(19) United States
(12) Patent Application Publication
(10) Pub. No.: US 2014/0292642 A1
(43) Pub. Date: Oct. 2, 2014

(54) METHOD AND DEVICE FOR DETERMINING AND REPRODUCING VIRTUAL, LOCATION-BASED INFORMATION FOR A REGION OF SPACE

(71) Applicants: Lars Schubert, Stuttgart (DE); Mathias Grube, Leinfelden-Echterdingen (DE); Armand Heim, Reutlingen (DE); Stefan Tuerck, Mittelbiberach (DE)

(72) Inventors: Lars Schubert, Stuttgart (DE); Mathias Grube, Leinfelden-Echterdingen (DE); Armand Heim, Reutlingen (DE); Stefan Tuerck, Mittelbiberach (DE)

(73) Assignee: IFAKT GMBH, Stuttgart (DE)

(21) Appl. No.: 14/125,684

(22) PCT Filed: Jun. 13, 2012
(86) PCT No.: PCT/EP2012/061195

§ 371 Date: Mar. 14, 2014

(30) Foreign Application Priority Data
Jun. 15, 2011 (DE) 10 2011 104 524.8

(51) Int. Cl. G06F 3/01

(52) U.S. Cl. CPC G06F 3/011
USPC 345/156

(57) ABSTRACT

The present invention relates to a method for determining and reproducing virtual, location-based information for a region of space, comprising the steps of:
using a sensor device to detect measurement data from at least one part of a body of a viewer in the region of space,
determining a posture of the viewer on the basis of the measurement data, identifying a spatial position of the viewer relative to the region of space,
determining a viewing direction of the viewer relative to the region of space on the basis of the spatial position and the posture,
determining the virtual, location-based information on the basis of the viewing direction, and
using a display device to reproduce the virtual, location-based information.

### CROSSREFERENCES TO RELATED APPLICATIONS

This application is a continuation of international patent application PCT/EP2012/061195, filed on Jun. 13, 2012 designating the U.S., which international patent application has been published in German language and claims priority from German patent application DE 10 2011 104 524.8, filed on Jun. 15, 2011. The entire contents of these priority applications are incorporated herein by reference.

### FIELD OF INVENTION

The present invention relates to a method and a corresponding device for determining and reproducing virtual, location-based information for a region of space. The present invention also relates to a control and analysis unit for a device for determining and reproducing virtual, location-based information for a region of space. In addition, the invention relates to a method for operating such a control and analysis unit. Finally, the present invention relates to a non-transitory computer-readable recording medium.

### BACKGROUND OF THE INVENTION

U.S. 2007/0164988 A1, for example, discloses a method and a device for determining and reproducing virtual, location-based information for a region of space. This document provides that a mobile device comprises a camera that can detect a surrounding area. An optical orientation of the camera relative to the device is adjusted according to a viewing angle of a user. An orientation of the pupils of the user relative to the device is measured and analyzed to determine the viewing angle. Then a position of the device is found and analyzed along with the optical orientation of the camera in order to be able to determine the virtual, location-based information. Finally, the device reproduces the virtual, location-based information.

### SUMMARY OF THE INVENTION

The object of the present invention is to provide a method and a device which, compared to conventional methods and devices, enable robust, fast and accurate determination and reproduction of virtual, location-based information for a region of space.

According to one aspect of the present invention, this object is achieved by a method of the type mentioned in the introduction, comprising the steps of:
using a sensor device to detect measurement data from at least one part of a body of a viewer in the region of space,
determining a posture of the viewer on the basis of the measurement data,
identifying a spatial position of the viewer relative to the region of space,
determining a viewing direction of the viewer relative to the region of space on the basis of the spatial position and the posture,
determining the virtual, location-based information on the basis of the viewing direction, and
using a display device to reproduce the virtual, location-based information.

According to a further aspect of the present invention, this object is achieved by a device of the type mentioned in the introduction, comprising a sensor device for detecting measurement data from at least one part of a body of a viewer in the region of space, a control and analysis unit for determining a posture of the viewer on the basis of the measurement data, for identifying a spatial position of the viewer relative to the region of space, for determining a viewing direction of the viewer relative to the region of space on the basis of the spatial position and the posture, and for determining the virtual, location-based information on the basis of the viewing direction, and a display device for reproducing the virtual, location-based information.

According to a further aspect of the present invention, a control and analysis unit is provided for using in a device of the type mentioned in the introduction, said unit comprising means for receiving measurement data from a sensor device, which detects measurement data from at least one part of a body of a viewer in the region of space, means for determining a posture of the viewer on the basis of the measurement data, means for identifying a spatial position of the viewer relative to the region of space, means for determining a viewing direction of the viewer relative to the region of space on the basis of the spatial position and the posture, means for determining the virtual, location-based information on the basis of the viewing direction, and means for providing the virtual, location-based information for reproducing the virtual, location-based information.

According to a further aspect of the present invention, a method is provided for operating a control and analysis unit of the type mentioned in the introduction, comprising the steps of:
receiving measurement data from a sensor device, which detects measurement data from at least one part of a body of a viewer in the region of space,
determining a posture of the viewer on the basis of the measurement data,
identifying a spatial position of the viewer relative to the region of space,
determining a viewing direction of the viewer relative to the region of space on the basis of the spatial position and the posture,
determining the virtual, location-based information on the basis of the viewing direction, and
providing the virtual, location-based information for reproducing the virtual, location-based information.

According to a further aspect of the present invention, a non-transitory computer-readable medium is provided that stores therein a computer program product, which, when executed by a processor, causes the method as disclosed herein to be performed.

The invention is based on the knowledge that the viewing direction of the viewer can be determined on the basis of the posture and spatial position of the viewer. If the viewing direction of the viewer relative to the region of space is known then it is possible to determine virtual, location-based information that is associated with a segment of the region of space at which the viewing direction is pointing. Tests by the applicant have shown that this approach advantageously is very robust to movements of the viewer, and produces very accurate results when determining and reproducing the virtual, location-based information. It is particularly advantageous that the invention does not require any special markers in the region of space or on the viewer. In particular, the posture is determined without special markers on the body of the viewer.

The viewer is detected by a sensor device which detects measurement data about the viewer. In this case, the sensor device can detect the entire viewer. Alternatively, it is possible that only a part of the body of the viewer is detected, from which the posture can be determined.

The sensor device advantageously comprises at least one imaging sensor, such as a digital camera, for instance, in order to detect the at least one part of the body of the viewer. When using imaging sensors, the relevant measurement data is detected in the form of image data.

The measurement data is used to determine the posture of the viewer. The posture is understood to mean a spatial orientation of at least one body part of the viewer, in particular of arms, torso and/or neck, or a part of the body part. It is preferable if the posture is determined on the basis of a plurality of body parts and the orientation of the body parts with respect to one another.

It is possible to infer from the posture which part of the region of space the viewer is looking at. In a preferred embodiment, the viewing direction is determined under the assumption that the viewer is holding the display device in at least one hand. Under the additional assumption that the viewer is looking at the display device, the viewing direction can be determined directly on the basis of the spatial orientation of the head and the arms. In an alternative embodiment, the viewing direction is determined under the assumption that the viewer is looking above the display device. Then the viewing direction can be determined on the basis of the spatial orientation of the head and the arms and a suitable adjustment that takes into account the display device. In a particularly preferred embodiment, the orientation of the head and the arms of the viewer with respect to one another is analyzed in order to determine automatically whether the viewer is looking at the display device or looking past the display device. Determining the viewing direction can then be adapted automatically to the given situation.

In order to be able to determine the viewing direction relative to the region of space, the spatial position of the viewer relative to the region of space is additionally determined. The spatial position can be represented in the region of space as a point in space having spatial coordinates, wherein the position of the point in space relative to the body of the viewer is known.

It is preferably provided that a sensor position and a sensor orientation of the sensor device within the region of space are known. The sensor position and/or the sensor orientation can be determined, for example by calibrating the sensor device. If sensor position and sensor orientation are known, it is sufficient to determine a position of the viewer relative to the sensor device, because this relative position can then be transformed on the basis of the sensor position and sensor orientation into the spatial position of the viewer relative to the region of space. It is necessary to identify the spatial position relative to the region of space in order to be able to determine correctly the virtual, location-based information on the basis of the viewing direction.

The virtual, location-based information preferably constitutes items of information that are associated with specific segments of the region of space. The association is then made within a virtual coordinate system in which the virtual, location-based information is organized. The orientation and position of the virtual coordinate system relative to the region of space are preferably known. If the viewing direction relative to the region of space is determined, it can be transformed into the virtual coordinate system in order to determine the location-based, virtual data.

In addition, it is preferably provided that virtual, location-based information is stored in a database. The database can be held, for example, in the control and analysis unit, the display device and/or in a network to which the control and analysis unit or the display device has access. The virtual, location-based information can be pieces of text, for example, that are associated with individual sections or points of the region of space. Alternatively or additionally, it can be graphical information that represents the viewed segment of the region of space virtually and preferably with additional information.

For example, it is possible that the viewer is located inside the unfinished shell of an aircraft fuselage. According to the viewing direction of the viewer, the viewer is presented with information about which components have to be fitted, tested or replaced. In addition, it is possible to show the viewer which operations must be carried out for the relevant task. This also provides a simple way of checking whether components are installed correctly.

As a further example, it is possible that the device and the method are used in a medical field. For instance, a doctor could be shown, according to the viewing direction of the doctor towards a patient, a choice of suitable CT images that relate to the patient's body area that the doctor is looking at.

As a further example, it is possible that a viewer inside a house is looking at an area of wall, and the viewer is shown parts of a plan of the house as virtual, location-based information. This can then inform the viewer about cabling or pipework or variations in the structure of the area of wall.

As a further example, it is possible that the viewer is located in a railway car. This railway car may be partially or fully constructed. According to the viewing direction of the viewer, the viewer is presented with virtual, location-based information about which components have to be fitted, tested or replaced. In particular in this case, the viewer can be given virtual, location-based information about how electrical cables and/or pressure pipelines are laid or are meant to be laid. Thus it is possible to show the viewer also which operations must be carried out for relevant tasks such as installation or maintenance tasks. This also provides a very simple way of checking whether components, in particular the electrical cables and pressure pipelines, are installed correctly.

As a further example, it is possible that the viewer is located in a partially or fully constructed hull of a ship. According to the viewing direction of the viewer, virtual, location-based information is presented to the viewer about which components have to be fitted, tested or replaced. In particular, electrical cables, pipelines and panel sections can be included in this information. It is also possible that entire assemblies to be built into the hull of the ship are displayed, such as for example a bridge or a ship's engine. Moreover, it is possible to display to the viewer, virtual, location-based information about safety-related points such as, for example, heavily stressed weld joints. The viewer can then use this information to check the relevant points and, if applicable, compare with reference data. In addition, it is possible to show the viewer which operations must be carried out for the relevant task. This also provides a simple way of checking whether components are installed correctly. Furthermore, it is possible to provide the viewer with virtual, location-based information about passenger cabins, such as, for example, information about interior fittings of the relevant passenger cabins and information about existing cables behind wall panels for maintenance work.

As a further example, it is possible that the device and the method are used in road building. According to the viewing direction of the viewer towards a road, the viewer can then, for example, obtain virtual, location-based information about the structure below the road. In particular, the viewer can be provided with virtual, location-based information about lines such as pipelines, gas pipes and electrical cables. In other words, the viewer can look virtually through the road into the ground. In addition, it is possible for the viewer to be shown in the form of virtual, location-based information, sections from a relevant construction drawing for a viewed area in the viewing direction. This is a quick and easy way to inform the viewer of appropriate construction work. In addition, it is very easy for the user to compare operations that have already been performed with reference information.

As a further example, it is possible that the device and the method are used in a cellular manufacturing system employing an assembly cell. Cellular manufacturing systems are used, for example, in the production of engines, in particular internal combustion engines. In these systems, the motor is arranged centrally, with an assembly operator able to move around the engine in order to be able to work on it from different sides. In this case, the method and device according to the invention make it possible to provide the assembly operator, according to his position, directly with the virtual, location-based information that the assembly operator needs for operations in the area in which he is located. In particular for cellular manufacturing, it is possible that the display device is a fixed monitor or a pivotable monitor. For instance it can be rotatably arranged above the assembly cell. Alternatively or additionally, it is possible for a plurality of monitors to be used simultaneously, which can be viewed from different positions of the assembly operator. In this case, it is possible to show the assembly operator which operations need to be performed for the relevant tasks in the area at which the assembly operator's viewing direction is pointing. In addition, the assembly operator can be shown which components are required for these tasks. Furthermore, the assembly operator can be shown how to fit the parts and which way the parts are meant to face when fitted. Moreover, it is also very easy to be able to check that the components are fitted correctly.

The display device is preferably designed such that it can reproduce the virtual, location-based information. Alternatively or additionally, it is possible to reproduce the virtual, location-based information acoustically and/or haptically. Additional reproduction options can thereby be added to the aforementioned examples. In addition, it is possible that acoustic and/or haptic reproductions can give people who have a visual impairment information about the relevant part of the region of space.

A further advantage of the invention is that the virtual, location-based information can be determined irrespective of a position of the display device. Only the virtual, location-based information that corresponds to the actual viewing direction of the viewer is determined and reproduced. This simplifies a control system for reproducing the virtual, location-based information, because this information is selected implicitly by movements of the viewer and can be adapted accordingly.

In addition, it is possible that the viewing direction can be inhibited by manual input by the user. It is intended here that the viewer fixes the viewing direction and hence the currently displayed virtual, location-based information. The viewer can thus move freely in the region of space without changing the information on the display device that is relevant to the viewer.

Alternatively or additionally, it is possible that the viewer can manipulate the viewing direction manually, for example by means of an input device such as a mouse, a trackball or a touchscreen. The viewer can thus additionally and selectively retrieve relevant information that does not depend on the posture of the viewer, if this information is required.

It is preferable if the control and analysis unit is in the form of a computer, for example a PC. In further preferred embodiments, the control and analysis unit can be composed of a multiplicity of processing units such as, for example, microprocessors, which communicate with one another. In addition, the sensor device and/or the display device can comprise in-device processing units. The control and analysis unit can hence be designed as a discrete unit. Alternatively, it can be designed as the combination of a plurality of processing units, wherein these processing units are preferably arranged in different modules of the device according to the invention. As a further alternative, the control and analysis unit can also be integrated entirely in the sensor device and/or the display device.

In an embodiment of the invention, three-dimensional measurement data is detected as the measurement data. In this embodiment, the posture of the viewer is then determined on the basis of three-dimensional measurement data. The measurement data comprises depth information in addition to height and width information. This allows the posture of the viewer to be determined particularly precisely. Using three-dimensional measurement data also makes it possible to identify the spatial position of the viewer even more precisely.

The sensor device can comprise a 3D camera, for example a stereo camera, as the sensor in order to detect the three-dimensional measurement data. In further preferred embodiments, the sensor device comprises as the sensor a digital (2D) camera, an infrared depth sensor, a laser depth sensor, a time-of-flight camera and/or an ultrasound sensor.

In a further embodiment of the invention, the sensor device is arranged in the region of space independently of the viewer. In this embodiment, the sensor device is arranged apart from, and physically independent of, the viewer. An advantage here is that the viewer-independent arrangement means that the sensor position and the sensor orientation can be established very accurately. This advantageously results in the viewing direction of the viewer being detected particularly accurately.

In addition, it is possible to adapt the sensor device automatically or by selective control by the viewer to the spatial position of the viewer. The sensor device can thereby track the viewer in order to cover a larger region of space.

In a further embodiment of the invention, the sensor device is arranged in a fixed position in the region of space. In this embodiment, the sensor device is fixed relative to the region of space. This results in a constant sensor position, making it easier and faster to identify the spatial position. It also results in the advantage that the sensor device, for example needs to undergo initial measurements and calibration only once before use, making it possible to detect highly accurate measurement data. An additional advantage is that the sensor device can be calibrated very accurately with respect to interference effects such as light and shadow conditions, in the detected part of the region of space. The accuracy can thereby be improved further by taking into account the effects of interference of the region of space on the sensor device.

In a further embodiment of the invention, the sensor device automatically determines a sensor position relative to the region of space. In this embodiment, the sensor position is determined, for example, directly on the basis of the measurement data from the sensor device. This can be done during a calibration process, for instance.

The sensor device preferably detects the region of space within a sensor field and aligns the relevant measurement data with virtual data about the structure of the region of space. One advantage here is that the sensor device can be calibrated particularly quickly and accurately. In addition, it is possible to determine repeatedly the sensor position and therefore guarantee permanently very high accuracy when determining the viewing direction.

Alternatively or additionally, it is possible that the sensor device uses a position sensor to determine the sensor position. The sensor device preferably comprises the position sensor. The position sensor can be in the form of a GPS sensor, for example. The GPS sensor has the advantage that the sensor position can be determined very accurately even when the region of space is initially unknown to the sensor device. It is particularly preferred if the GPS sensor is a differential GPS sensor. Alternatively or additionally, it is possible that radio positioning systems are used. Such radio positioning systems determine the sensor position using radio direction-finding and/or triangulation. They have the advantage that they can be used in enclosed spaces and they determine the sensor position with high accuracy. Such radio direction-finding systems can be implemented, for example, by means of WLAN, Bluetooth and/or UMTS. As another alternative, it is possible to use laser sensors to determine the sensor position.

In a further embodiment, the sensor device automatically determines a sensor orientation relative to the region of space. In this embodiment, the sensor orientation is determined directly on the basis of the measurement data from the sensor device. This can be done during a calibration process, for instance.

The sensor device preferably detects the region of space within the sensor field and aligns the relevant measurement data with virtual data about the structure of the region of space. One advantage here is that the sensor device can be calibrated particularly quickly and accurately. In addition, it is possible to determine repeatedly the sensor orientation and therefore guarantee permanently very high accuracy when determining the viewing direction.

Alternatively or additionally, it is possible that the sensor device uses an attitude and position sensor to determine the sensor attitude and position. The attitude and position sensor can be in the form of a GPS sensor, accelerometer and/or compass chip for example. These attitude and position sensors have the advantage that the sensor attitude and position can be determined very accurately even when the region of space is initially unknown to the sensor device. It is particularly preferred if the GPS sensor is a differential GPS sensor. Alternatively or additionally, it is possible that radio positioning systems are used. Such radio positioning systems determine the sensor attitude and position using radio direction-finding and/or triangulation. They have the advantage that they can be used in enclosed spaces and they determine the sensor attitude and position with high accuracy. Such radio direction-finding systems can be implemented, for example, by means of WLAN, Bluetooth and/or UMTS. As another alternative, it is possible to use laser sensors to determine the sensor attitude and position.

In a further embodiment, a multiplicity of sensor devices are used. In this embodiment, the multiplicity of sensor devices are used to detect the measurement data jointly.

It is preferably provided that different sensor devices detect different or at least partially different segments of the region of space. The sensor field in which the viewer is detected can thereby be increased.

Alternatively or additionally, it is possible that a plurality of sensor devices jointly detect a segment of the region of space. One advantage here is that the viewer is detected from different directions and hence the measurement data from the sensor devices can be compared with one another. It is thus possible to achieve a greater accuracy and robustness in identifying the spatial position and determining the posture of the viewer.

In a further embodiment of the invention, at least an arm region of the viewer is used as the at least one part of the body of the viewer. In this embodiment, only one part of the body of the viewer is taken into account to determine the viewing direction. Tests by the applicant have shown that measurement data from the body of the viewer from the region of the arms is sufficient to be able to determine the viewing direction very accurately. One advantage of this is that this reduces the measurement data to be processed and hence speeds up execution of the method while maintaining the measurement accuracy.

In this embodiment it is in particular possible to detect a spatial orientation and a spatial position of the lower arm and upper arm of the viewer in order to generate the viewing direction. The viewing direction can then be determined, for example, under the assumption that it extends along the lower arm. Thus the viewer can use the lower arm in a similar way to a pointer in order to specify the viewing direction to the device. In this embodiment, it is particularly preferred that only an arm of the viewer is taken into account. Tests by the applicant have shown that taking into account only an arm of the viewer can generally provide very robust and accurate results.

In addition, it can be provided that a shoulder region of the viewer is additionally taken into account. A spatial orientation of the entire arm can be determined even more accurately on the basis of the shoulder region.

In addition, it can be provided that a base of the neck of the viewer is additionally taken into account. A spatial orientation of the head can be determined on the basis of the base of the neck. One advantage here is that the accuracy is further increased. This embodiment is particularly advantageous when a direction from the head of the viewer to an area of the hands of the viewer is assumed to be the viewing direction.

In a further embodiment of the invention, at least a chest region of the viewer is used as the at least one part of the body of the viewer. In this embodiment, it is likewise only a part of the body of the viewer that is taken into account to determine the viewing direction. Tests by the applicant have shown that information about the posture of the viewer in the region of the chest is already sufficient to be able to determine the viewing direction. One advantage in this case is the particularly large reduction in measurement data to be processed and hence a particularly large increase in the execution speed of the method.

This embodiment is particularly advantageous when a direction extending orthogonally from the chest region of the viewer is assumed to be the viewing direction. In this case, the chest region is preferably simplified by treating it as a plane, with the viewing direction then being the normal to this plane.

In a further embodiment of the invention, a skeleton model is formed on the basis of the measurement data, and the skeleton model is used to determine the posture of the viewer. In this embodiment, the at least one part of the body of the viewer is initially approximated as a skeleton model. This typically results in a highly simplified representation of the viewer similar to a “stick figure”. The skeleton model provides a simplified representation of body parts of the viewer as straight lines. In addition to the simplified body parts, the skeleton model preferably comprises pivot points which provide a pivoting joint between the individual body parts. The skeleton model additionally comprises for each pivot point an angle between the respective body parts, which angles uniquely define the posture. The posture and future possible movements of the viewer can advantageously be determined and analyzed very easily and with little computing effort on the basis of these simplified body parts and pivot points.

The skeleton model is preferably dependent on the part of the body of the viewer that is detected by the sensor device. In other words, only a part of the body of the viewer is taken into account and hence the skeleton model is also only generated from this part. An advantage here is a further reduction in the data required and hence a reduction in the computing effort.

It is also preferred that the spatial position represents a point in space inside the skeleton model. This point in space can then be arranged as a fixed point inside the skeleton model. Thus on the basis of the posture, the viewing direction can be determined very easily with respect to this fixed point, and then transformed into a coordinate system of the region of space.

In a further embodiment of the invention, a movement of the viewing direction is detected, and the viewing direction is determined on the basis of the movement. In this embodiment of the invention, the previous movement of the viewing direction is taken into account in determining the viewing direction. Changes in the viewing direction over time are thus detected and analyzed. Then the previous movement is used to determine the viewing direction with even greater accuracy. For example, future viewing directions can be calculated in advance. One advantage of this is that relevant virtual, position-related information can be pre-stored, speeding up the method overall.

In addition, it is possible to filter the movement so that motion smoothing, for instance motion filtering using a low-pass filter, can be used in determining the viewing direction. One advantage here is that the viewing direction can be determined even more accurately, and interference effects such as sensor noise, for example, can be reduced. Hence this results in a particularly stable, smooth and interference-free reproduction of the actually required virtual, location-based information. It also results in the advantage that the determined virtual, location-based information coincides particularly accurately with the actual viewing direction of the viewer because interference effects are minimized.

In a further embodiment of the invention, CAD data is used as the virtual, location-based information. At least some of the virtual, location-based information is based on CAD data. One advantage here is that CAD data is typically already available in industrial applications. In addition, this CAD data is typically available as three-dimensional models.

It is particularly preferred if the CAD data provides a virtual model of at least part of the region of space itself. The viewing direction can thereby be transformed into a virtual coordinate system of the CAD data. A viewed segment of the region of space can then be determined on the basis of the viewing direction. Then the respective virtual, location-based information can thus be determined directly. This achieves a particularly simple assignment of the viewing direction to the corresponding virtual, location-based information. In addition, it results in the advantage that existing systems can be used together with the invention very easily and economically.

In a further embodiment of the invention, a tablet computer is used as the display device. In this embodiment, the display device is embodied as a mobile unit in the form of a tablet computer. The term tablet computer is understood to mean in particular mobile devices that comprise at least one screen and a graphics processor for reproducing the virtual, location-based data, for instance such as a tablet PC or a mobile phone.

Alternatively or additionally, it is possible that the display device is designed as a head-up display. The head-up display can be embodied, for example, as data goggles that are worn by the viewer. In this case, the data goggles comprise at least one visual reproduction means that can reproduce the virtual, related information.

In particularly preferred embodiments, the display device comprises a wireless transceiver such as, for example, Bluetooth and/or WLAN. The display device can thus receive, for example, data about the viewing direction and/or the virtual, location-based information. One advantage here is that the freedom of movement of the viewer is not restricted. A further advantage is that such mobile display devices are available very easily and economically for industrial purposes. It is thereby possible to produce the device economically and to implement the method economically.

In a further preferred embodiment, the display device comprises an attitude and position sensor. The attitude and position sensor can be in the form of a GPS sensor, compass chip and/or accelerometer, for instance. The attitude and position sensor of the display device determines a spatial position and/or spatial orientation of the display device itself. This spatial position and/or spatial orientation of the display device can be provided to the control and analysis unit. The control and analysis unit can then use this additional information to check the viewing direction and/or take into account this information when determining the viewing direction. This is particularly advantageous when the viewing direction is assumed to come from the head of the viewer towards or above the display device. A radio positioning system based on WLAN, Bluetooth or UMTS, for instance, is also possible as the attitude and position sensor.

In a further embodiment of the invention, additional real, location-based information is reproduced on the display device. In this embodiment, the virtual, location-based information is displayed simultaneously with the real, location-based information. For instance, the virtual, location-based information can be superimposed on the real-location-based information.

It is preferable if the display device comprises a camera which detects the segment of the region of space into which the viewing direction is pointing. In addition, it is possible to adapt automatically an orientation of the camera for the real, location-based information on the basis of the viewing direction. Alternatively, it is possible that a camera is arranged in the area of the viewer, for example as a helmet camera or finger camera, in order to detect the real, location-based information. The finger camera is particularly advantageous when the viewing direction is determined on the basis of the arm position, wherein the viewing direction represents an extension of the lower arm of the viewer. One advantage here is that the viewer is presented with additional real information which associates the virtual, location-based information directly with the real region of space.

### BRIEF DESCRIPTION OF THE DRAWINGS

The invention is described in greater detail below with reference to exemplary embodiments that have no limiting effect on the invention, and with regard to drawings, in which:

FIG. 1 shows a preferred usage location of the invention,

FIG. 2 shows a schematic diagram of an exemplary embodiment of the device according to the invention,

FIG. 3 shows a schematic diagram of different coordinate systems for determining a viewing direction,

FIG. 4 shows a first skeleton model of a viewer, wherein the viewing direction is established from an arm region, shoulder region and head region of the viewer,

FIG. 5 shows a second skeleton model of a viewer, wherein the viewing direction is established according to a chest region of the viewer, and

FIG. 6 shows a flow diagram of a preferred exemplary embodiment of the method according to the invention.

### DESCRIPTION OF PREFERRED EMBODIMENTS

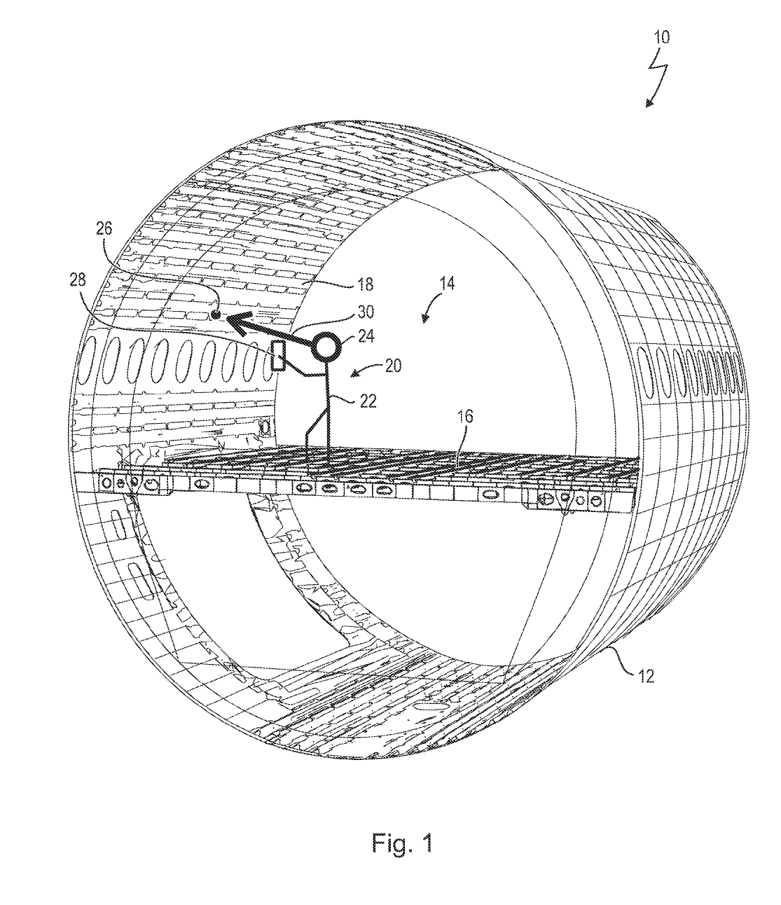

FIG. 1 shows a typical usage area 10 of the invention in an example application. The usage area 10 is formed by an aircraft fuselage 12, a section of which is shown schematically here. A region of space 14 is formed inside the aircraft fuselage 12. The region of space 14 is bounded by a floor 16 and a wall 18. The region of space 14 is open on two sides because of the schematic representation. A viewer 20 is located inside the region of space 14. The body 22 and hence also the head 24 of said viewer are oriented towards a viewed segment 26 of the region space 14 on the wall 18. The viewer 20 is holding a display device 28 in his hands. The display device 28 reproduces virtual, location-based information related to the viewed segment 26 of the region of space 14.

In the usage area 10 shown, for example, information about which production steps have to be performed in the viewed segment 26 of the region of space 14 can be presented to the viewer 20 as virtual, location-based information. It is also possible that the viewer is given virtual, location-based information about which components must already be present in the viewed segment 26 of the region of space 14 so that it is possible to assess production steps that have already been made or are still to be made. The invention allows the viewer 20 to move freely in the region of space 14 while the virtual, location-based information associated with the viewed segment 26 of the region of space 14 is presented simultaneously to the viewer very accurately on the display device 28.

The viewer 20 here looks above and beyond the display device 28 to the viewed segment 26 of the region of space 14. This is done in a viewing direction 30 from the head 24 of the viewer 20 to the viewed segment 26 of the region of space 14 on the wall 18.

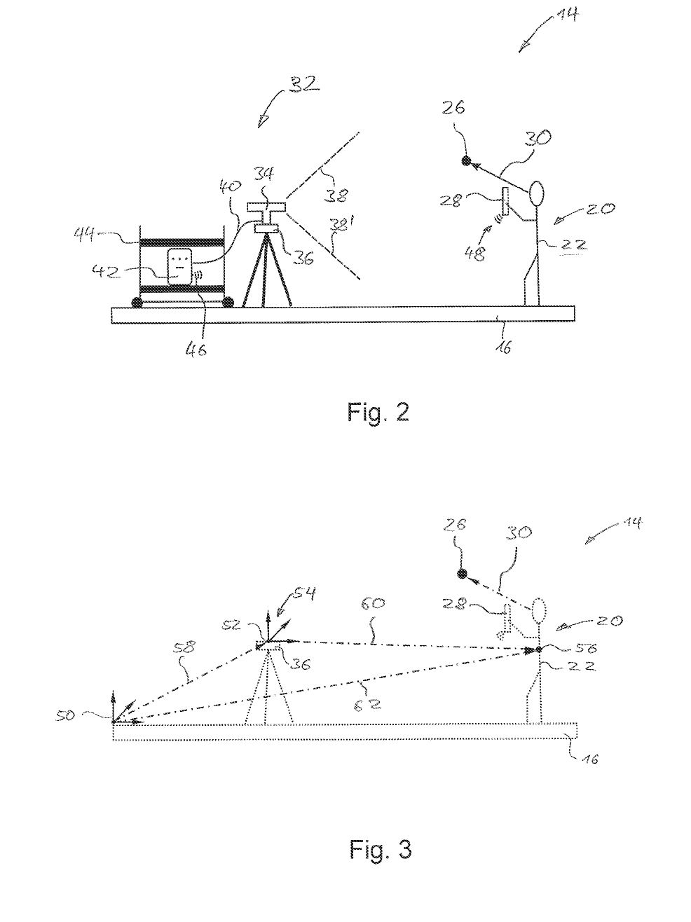

FIG. 2 shows the viewer 20 in schematic form together with a device 32 for determining and reproducing the virtual, location-based information. The device 32 comprises a sensor device 34 in addition to the display device 28. The sensor device 34 is arranged on a tripod 36. This results in the sensor device 34 being arranged in a fixed position in relation to the region of space 14. In addition, the sensor device 34 is arranged independently of the viewer in the region of space 14. The sensor device 34 comprises a 3D camera as the sensor. The 3D camera comprises a digital camera and an infrared depth measurement sensor. It is pointed out here for the sake of completeness that the sensor device is not restricted to the use of a 3D camera and an infrared depth measurement sensor. The individual sensors of the sensor device 34 are not shown here for reasons of clarity.

The sensor device 34 detects the viewer 20 within a sensor field, which is shown schematically here by straight lines 38 and 38′. The sensor field shown detects the entire viewer 20. Sensor fields that detect only parts of the body 22 of the viewer 20 are also possible.

The information detected in the sensor field by the sensor device 34 is converted into three-dimensional measurement data, which is sent over a line 40 to a computer 42. Alternatively it is possible that the line 40 is designed as a wireless radio link. The computer 42 is likewise part of the device 32. It is arranged on a trolley 44 for reasons of portability. The computer 42 receives the three-dimensional measurement data and then determines the viewing direction 30 of the viewer 20.

The computer 42 further comprises a transceiver 46. The computer 42 then sends the viewing direction 30 via the transceiver 46 to the display device 28. For this purpose, the display device 28 likewise comprises a transceiver 48. The transceivers 46 and 48 are preferably designed as wireless transceivers 46 and 48. The viewer 20 thus has maximum possible freedom of movement within the region of space 14.

The display device 28 determines on the basis of the viewing direction 30 which segment 26 of the region of space 14 is currently being looked at by the viewer 20. For this purpose, the display device 28 comprises a processing unit (not shown). On the basis of this information, the virtual, location-based information is selected from a suitable database. Then the virtual, location-based information is reproduced by the display device 28. In this exemplary embodiment, the computer 42 and the processing unit of the display device 28 together form a control and analysis unit.

In FIG. 3, the region of space 14, the viewer 20 and part of the device 32 are represented using dashed lines. A coordinate system 50 is assigned to the region of space 14. This coordinate system 50 preferably corresponds to a virtual coordinate system for the virtual, location-based information inside the database. For example, this may be a reference system for CAD data.

The tripod 36 serves as a reference for the sensor device 34 in the region of space 14. The sensor position 52 is hence assumed to be a point in space on the tripod 36. The sensor position 52 is also an origin of a coordinate system 54 for the sensor device 34. The orientation of the coordinate system 54 defines a sensor orientation of the sensor device 34 within the region of space 14 and relative to the coordinate system 50. A spatial position 56 is assigned to the viewer 20. Likewise in this case, this spatial position 56 is embodied as a point in space, which is located inside the body 22 of the viewer 20.

A space-sensor vector 58 is resultant that extends from the coordinate system 50 to the sensor position 52. This vector 58 is known to the sensor device 34 and/or to the control and analysis unit, for example from a calibration process. The sensor device 34 detects the measurement data in the coordinate system 54. This measurement data can be transformed into the coordinate system 50 of the region of space 14 on the basis of the known space-sensor vector 58. This transformation takes into account the position and orientation of the coordinate system 54 with respect to the coordinate system 50. In addition, a sensor-viewer vector 60 extends from the sensor position 52 to the spatial position 56. This sensor-viewer vector 60 is determined on the basis of the measurement data. The spatial position 56 can be represented in the coordinate system 50 by transformation of the sensor-viewer vector 60. This results in a space-viewer vector 62, which defines the spatial position 56 of the viewer 20 relative to the space 14.

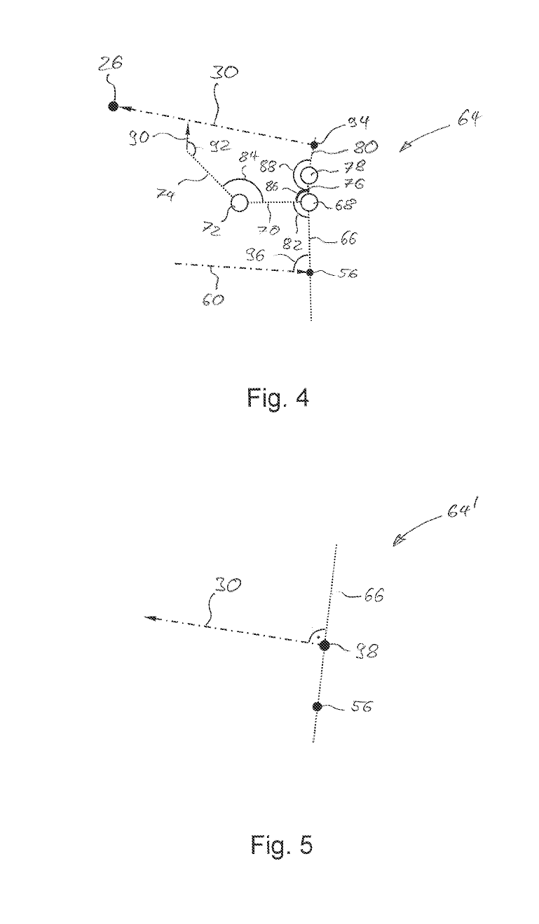

FIG. 4 shows a skeleton model 64 of the viewer 20. The skeleton model 64 represents inside the computer 42 the posture of the viewer 20. The posture of the viewer 20 can be analyzed on the basis of the skeleton model 64, and hence the viewing direction 30 can be determined. The skeleton model 64 is a three-dimensional skeleton model. For reasons of clarity, it is shown in two dimensions here. The skeleton model 64 comprises simplified representations of the individual body parts of the viewer 20 in the form of straight lines. These representations are connected to one another by pivot points. In addition, angles are defined between the individual body parts in order to be able to represent the posture fully and specifically.

The skeleton model 64 shown here corresponds to a part of the body 22 of the viewer 20. It represents a chest region, an arm region, a neck region and a head region of the viewer 20. For the purpose of representing these regions of the body 22, the skeleton model 64 accordingly comprises a chest part 66. This is connected to an upper-arm part 70 via a shoulder joint 68. The upper-arm part 70 is further connected to a lower-arm part 74 via an elbow joint 72. A neck part 76 extends from the shoulder joint 68 to a joint 78. The joint 78 represents an ability of the head 24 of the viewer 20 to pivot. A head part 80 extends from the joint 78.

Each of the joints 68, 72 and 78 are assigned appropriate angles that define the spatial orientation of the individual body parts. An angle 82 specifies a relative spatial orientation of the chest part 66 to the upper-arm part 70. An angle 84 specifies a relative spatial orientation of the upper-arm part 70 to the lower-arm part 74. A further angle 86 specifies a relative spatial orientation of the upper-arm part 70 to the neck part 76. A further angle 88 specifies a relative spatial orientation of the neck part 76 to the head part 80.

The posture of the viewer 20 in space can be specified very accurately on the basis of this information. In order to determine the viewing direction 30, it is additionally assumed here that the viewer 20 is looking above the display device 28. Thus an obstacle 90 of predefined length is additionally taken into account, which obstacle extends from one end of the lower-arm part 74 at an angle 92.

The viewing direction 30 is determined by defining on the head part 80 an origin point 94 from which the viewing direction 30 extends. The viewing direction 30 then runs from the origin point 94 and passes above the obstacle 90. In order to specify the posture in the coordinate system 50 of the region of space 14, the spatial position 56 and an angle 96 between the sensor-viewer vector 60 and the chest part 66 are additionally taken into account. The overall result of this is the viewing direction 30 inside the coordinate system 50.

Which part 26 of the region of space 14 the viewer 20 is currently looking at is then determined on the basis of the viewing direction 30 and the stored virtual information about the region of space 14.

In addition, an alternative, simplified option for determining the viewing direction is possible. This alternative is not shown explicitly in the figures. A simplified skeleton model of the viewer is established in order to determine the viewing direction. The skeleton model then comprises merely an upper-arm part 70 and a lower-arm part 74, as they are shown in FIG. 4. In this embodiment, the viewing direction is determined under the assumption that the viewing direction extends from the elbow joint 72 through the lower-arm part 74. Hence the viewing direction can be determined in a similar way to the viewing direction 30 in FIG. 4, with the viewing direction corresponding to a pointing direction of the viewer. The viewer can then use the detected arm in a similar way to a pointer in order to change the viewing direction. The advantage here is that highly intuitive control of the viewing direction is possible while enabling the viewing direction to be determined very easily. A further advantage is that using the lower-arm part to identify directly the viewing direction increases the stability in determining the viewing direction.

FIG. 5 shows a further, simplified option for determining the viewing direction 30. In this case, the viewing direction 30 is determined under the assumption that it runs as a normal to a chest region of the viewer 20. Under this assumption, it is sufficient to detect the spatial orientation of the chest part 66 as a skeleton model 64′. The viewing direction 30 can then be determined as a normal to the chest part 66 extending from a predefined origin point 98. The chest part 66 is preferably represented as a plane in order to be able to determine the orientation of the viewing direction 30 in space simply and uniquely.

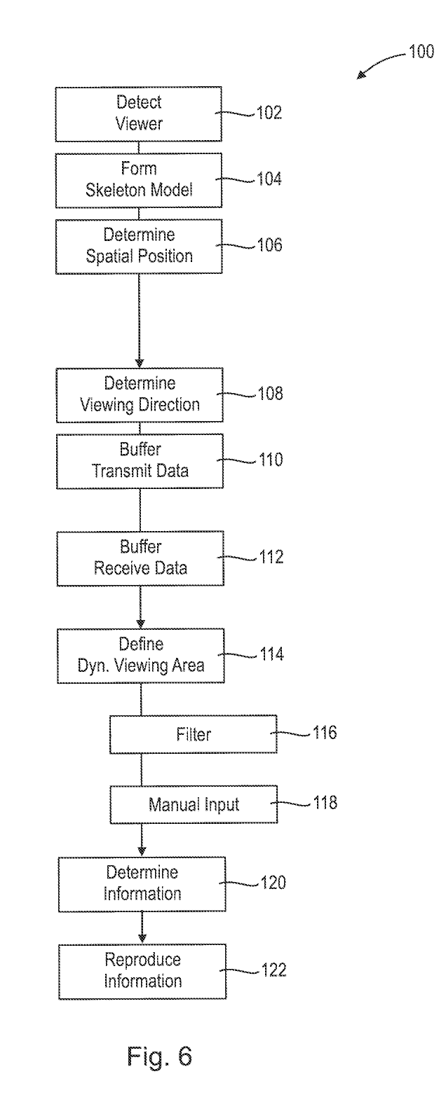

FIG. 6 shows a flow diagram 100 of an exemplary embodiment of the method according to the invention. In a first step 102, the viewer 20 is detected by the sensor device 34. This is done by means of the digital camera, which captures color images as measurement data. In addition, the infrared depth sensor is used to detect depth information as measurement data. The measurement data from the digital camera and from the infrared depth sensor together provide three-dimensional measurement data, which is sent to the computer 42.

In a further step 104, the computer 42 forms the skeleton model 64 of the viewer on the basis of the three-dimensional measurement data.

In addition, in step 106, the spatial position 56 of the viewer is identified on the basis of the three-dimensional measurement data.

In a step 108, the viewing direction 30, as explained above, is determined on the basis of the skeleton model 64, and hence on the basis of the posture of the viewer 20 and the spatial position 56.

In a step 110, the viewing direction 30 determined in this way is then buffered as transmit data in a transmit buffer in the computer 42. The transmit data is transmitted to a corresponding receive buffer in the display device 28, which buffers the transmit data as receive data. The purpose of buffering the transmit data in step 110 and buffering the receive data in step 112 is to ensure that the virtual, location-based information is reproduced reliably and smoothly even when unusable or unexpected measurement data is detected by the sensor device 34, or a communication link between the computer 42 and the display device 28 is temporarily unavailable.

In a further step 114, a dynamic viewing area is defined. This is performed by a sliding-window-frame calculation, which takes into account a previous movement of the viewing vector 30. Defining the dynamic viewing area prepares for the virtual, location-based information to be displayed on the display device as a sliding view. In other words, the virtual information follows the viewing direction 30 seamlessly. This results in a dynamic display of the virtual, location-based information, wherein rather than separate images being displayed regardless of the movement of the display device 28, smooth transitions are possible between the displayed virtual, location-based information.

Smoothing of the movement of the viewing direction is preferably additionally carried out in step 114. This can be done, for example, by performing a Fast Fourier Transform on the viewing direction 30 in conjunction with low-pass filtering and an inverse Fast Fourier Transform. The result in terms of the image is that the virtual, location-based information reproduced by the display device 28 slides particularly smoothly and synchronously with the movements of the viewing direction 30.

In a further step 116, the data obtained in step 114 is filtered in order to minimize computing effort. In this case, a frame rate for reproducing the virtual, location-based information on the display device 28 is reduced. The frame rate is preferably reduced to three frames per second.

In a further step 118, there is additionally the option for the viewer 20 to modify manually the currently reproduced virtual, location-based information. The viewer 20 can fix a viewing direction 30 that currently exists. The viewer can thereby view the currently displayed virtual, location-based information independently of the movements made by the viewer. It is additionally provided that the viewing direction 30 can be modified by manual inputs by the user 20 in the user's display device 28. For this purpose, the display device 28 comprises input means such as a touchscreen, for example, which the viewer 20 can use to adjust the viewing direction 30 manually.

In a further step 120, the virtual, location-based information is determined on the basis of the viewing direction 30, which information corresponds to the respective viewing direction 30.

Finally in step 122, the virtual, location-based information obtained in this way is reproduced.

The present invention thus enables very robust, fast and accurate determination and reproduction of virtual, location-based information while ensuring simple operation by the viewer. In addition, the invention enables the viewer to manage without special markers for this purpose on the body. In all, the invention gives the viewer a maximum possible freedom to view his surroundings at the same time as providing robustness, speed and accuracy of the determined and reproduced location-based information.

In further exemplary embodiments, which are not shown here, the control and analysis unit can have a different design. For instance, the computer 42 can also determine the virtual, location-based information, wherein then, for example, only graphics information is transmitted to the display device, similar to a terminal system. It is also possible that the display device 28 provides the entire control and analysis unit, wherein then an external computer 42 would be dispensed with. In addition, it is possible to integrate the control and analysis unit partially or fully in the sensor device 34. These exemplary embodiments in particular result in a very compact embodiment of the device 32. At the same time there is the possibility that already available components such as existing sensor devices and/or display devices can be used to produce the device economically.

The invention has been presented by way of example and described in detail with reference to the figures. This presentation and description shall be understood to be illustrative or exemplary but not limiting. It is self-evident that the above-mentioned features can be used not only in the stated combination in which they appear but also in other combinations or in isolation, without departing from the scope of the present invention.

In the claims, the term “comprising” does not exclude further elements or steps. In addition, using indefinite articles does not rule out the existence of a multiplicity of similar elements or the execution of a multiplicity of similar steps. A single element or another unit can perform the functions of a plurality of elements in the claims. The mere fact that certain measures are described in different dependent claims does not rule out the possibility of using a combination of these measures together.

A computer program can be stored or provided in a suitable non-volatile medium such as, for example, an optical storage medium or a solid-state medium together with, or as part of, further hardware. The computer program, however, can also be provided in another way, for example via the Internet or other wired or wireless telecommunication systems.

Reference signs in the claims do not limit the scope of said claims.

1. A method for determining and reproducing virtual, location-based information for a region of space, comprising the steps of:
using a sensor device to detect measurement data from at least one part of a body of a viewer in the region of space,
determining a posture of the viewer on the basis of the measurement data,
identifying a spatial position of the viewer relative to the region of space,
determining a viewing direction of the viewer relative to the region of space on the basis of the spatial position and the posture,
determining the virtual, location-based information on the basis of the viewing direction, and
using a display device to reproduce the virtual, location-based information.

2. The method as claimed in claim 1, characterized in that three-dimensional measurement data is detected as the measurement data.

3. The method as claimed in claim 1, characterized in that the sensor device is arranged in the region of space independently of the viewer.

4. The method as claimed in claim 1, characterized in that the sensor device (34)4s arranged in a fixed position in the region of space.

5. The method as claimed in claim 1, characterized in that the sensor device automatically determines a sensor position relative to the region of space.

6. The method as claimed in claim 1, characterized in that the sensor device automatically determines a sensor orientation relative to the region of space.

7. The method as claimed in claim 1, characterized in that a multiplicity of sensor devices are used.

8. The method as claimed in claim 1, characterized in that at least an arm region of the viewer is used as the at least one part of the body of the viewer.

9. The method as claimed in claim 1, characterized in that at least a chest region of the viewer is used as the at least one part of the body of the viewer.

10. The method as claimed in claim 1, characterized in that a skeleton model is formed on the basis of the measurement data, and the skeleton model is used to determine the posture of the viewer.

11. The method as claimed in claim 1, characterized in that a movement of the viewing direction is detected, and the viewing direction is determined on the basis of the movement.

12. The method as claimed in claim 1, characterized in that CAD data is used as the virtual, location-based information.

13. The method as claimed in claim 1, characterized in that a tablet computer is used as the display device 28.

14. The method as claimed in claim 1, characterized in that additional real, location-based information is reproduced on the display device.

15. A device for determining and reproducing virtual, location-based information for a region of space, comprising;
a sensor device for detecting measurement data from at least one part of a body of a viewer in the region of space,
a control and analysis unit for determining a posture of the viewer on the basis of the measurement data, for identifying a spatial position of the viewer relative to the region of space, for determining a viewing direction of the viewer relative to the region of space on the basis of the spatial position and the posture, and for determining the virtual, location-based information on the basis of the viewing direction,
and a display device for reproducing the virtual, location-based information.

16. A control and analysis unit for a device for determining and reproducing virtual, location-based information for a region of space, comprising
means for receiving measurement data from a sensor device, which detects measurement data from at least one part of a body of a viewer in the region of space,
means for determining a posture of the viewer on the basis of the measurement data,
means for identifying a spatial position of the viewer relative to the region of space,
means for determining a viewing direction of the viewer relative to the region of space on the basis of the spatial position and the posture,
means for determining the virtual, location-based information on the basis of the viewing direction, and
means for providing the virtual, location-based information for reproducing the virtual, location--based information.

17. A method for operating a control and analysis unit for a device for determining and reproducing virtual, location-based information for a region of space, comprising the steps of:
receiving measurement data from a sensor device, which detects measurement data from at least one part of a body of a viewer in the region of space,
determining a posture of the viewer on the basis of the measurement data,
identifying a spatial position of the viewer relative to the region of space,
determining a viewing direction of the viewer relative to the region of space on the basis of the spatial position and the posture,
determining the virtual, location-based information on the basis of the viewing direction, and
providing the virtual, location-based information for reproducing the virtual, location-based information.

18. A non-transitory computer-readable recording medium that stores therein a computer program product, which, when executed by a processor, causes the method as claimed in claim 17 to be performed.
